(19) United States
(12) Patent Application Publication
(10) Pub. No.: US 2026/0348062 A1
(43) Pub. Date: Nov. 5, 2026

(54) SHAPEABLE FABRIC

(71) Applicant: Owens Corning Intellectual Capital, LLC, Toledo, OH (US)

(72) Inventors: Julien Jouannaux, Saint Ismier (FR); Nadege Boucard, Le Pont de Beauvosin (FR); David Blandin, La Ravoire (FR)

(21) Appl. No.: 19/100,195

(22) PCT Filed: Aug. 2, 2023
(86) PCT No.: PCT/EP2023/071387

§ 371 Date: Jan. 31, 2025

(30) Foreign Application Priority Data
Aug. 2, 2022 (EP) 22306167.2

(51) Int. Cl. D04H 1/52; B29C 70/22; B29K 67/00; B29K 77/00; B29K 105/08; B29K 307/04; B29K 309/08; D04H 1/4218; D04H 1/4242; D04H 1/4382; D04H 1/74

(52) U.S. Cl. CPC D04H 1/52; B29C 70/22; D04H 1/4218; D04H 1/4242; D04H 1/43835; D04H 1/74; B29K 2067/00; B29K 2077/00; B29K 2105/089; B29K 2307/04; B29K 2309/08; D10B 2331/041; D10B 2505/02

(57) ABSTRACT

Herein is described a shapeable fabric comprising: first fibers oriented in a first direction; second fibers orientated in a second direction; and a stitching system comprising an infusion component and a shaping component, the infusion and shaping components of stitching system forming a stitching pattern through the fabric, wherein the first fibers comprise glass fibers and/or carbon fibers, the second fibers comprise glass fibers and/or carbon fibers, and the second direction being within 0 to 90 degrees of the first direction.

### FIELD OF THE INVENTION

The present invention relates to shapeable fabrics including glass fibers and/or carbon fibers, in particular shapeable fabrics to reinforce structural components such as wind turbine components.

### BACKGROUND

It is known to use glass and/or carbon fibers to form reinforcement fabrics to reinforce structural components such as wind turbine blades or related components (e.g. spar caps).

Structural components containing reinforcement fabrics (reinforced structural components) are often formed by stacking layers of reinforcement fabrics in a mold, filling the mold with a resin, and curing the resin to form the component. This process can be time consuming.

Wind power and the use of wind turbines have gained increased attention as the quest for alternative energy sources continues. With increasing interests in generating more energy from wind power, technological advances in the art have allowed for increased sizes of wind turbines blades. Increasing the size of wind turbine blades also increases the time required to produce the wind turbine blades.

It would be desirable to provide improvements in efficiency of the production of reinforced structural components such as wind turbine blades.

### SUMMARY OF THE INVENTION

At its most general, the present invention provides a shapeable fabric comprising: first fibers oriented in a first direction; second fibers orientated in a second direction; and a stitching system comprising an infusion component and a shaping component, the infusion and shaping components of stitching system forming a stitching pattern through the fabric.

For example, described herein is a shapeable fabric comprising:
first fibers oriented in a first direction;
second fibers orientated in a second direction; and
a stitching system comprising an infusion component and a shaping component, the
infusion and shaping components of stitching system forming a stitching pattern through the fabric,
   wherein the first fibers comprise glass fibers and/or carbon fibers, the second fibers comprise glass fibers and/or carbon fibers, and the second direction being within 0 to 90 degrees of the first direction.

In a first aspect, the present invention provides a shapeable fabric comprising:
first fibers oriented in a first direction;
second fibers orientated in a second direction; and
a stitching system comprising an infusion component and a shaping component, the infusion and shaping components of stitching system forming a stitching pattern through the fabric,
wherein the first fibers comprise glass fibers and/or carbon fibers, the second fibers comprise glass fibers and/or carbon fibers, and the second direction being within 0 to 90 degrees of the first direction, and
   wherein the infusion component constitutes from about 15 wt. % to about 75 wt. % of the stitching system, and the shaping component constitutes from about 25 wt. % to about 85 wt. % of the stitching system.

In a second aspect, the present invention provides a fabric stack comprising at least two layers of a shapeable fabric described herein.

In a third aspect, the present invention provides a shaped component comprising a fabric stack described herein.

In a fourth aspect, the present invention provides a process for producing a shapeable fabric, the process comprising:
providing first fibers oriented in a first direction and second fibers oriented in a second direction, wherein the first fibers comprise glass fibers and/or carbon fibers, the second fibers comprise glass fibers and/or carbon fibers, and the second direction being within 0 to 90 degrees of the first direction;
stitching the first fibers and second fibers together using a stitching system, the stitching system comprising an infusion component and a shaping component, wherein the infusion component constitutes from about 15 wt. % to about 75 wt. % of the stitching system, and the shaping component constitutes from about 25 wt. % to about 85 wt. % of the stitching system.

In a fifth aspect, the present invention provides a process for producing a shaped component, the process comprising:
stacking a plurality of layers of a shapeable fabric as described herein to provide a fabric stack;
shaping the fabric stack; and
   heating the fabric stack at a temperature up to about 150 °C.

In an aspect, the present invention provides a roll of shapable fabric as described herein.

The present inventors have found that the shapeable fabrics described herein have excellent handleability as well as providing improvements in efficiency of the production of reinforced structural components such as wind turbine blades.

The present inventors have found that the present invention provides a shapeable fabric which provides improvements in the efficiency of the production of reinforced structure components such as wind turbine blades and related components. This is because these shapeable fabrics can be stacked and shaped (i.e. pre-shaped) before being incorporated into a reinforced structural component. The provision of the shapeable fabrics described herein has been found to surprisingly increase the speed at which a reinforced structural component, e.g. a wind turbine blade, can be produced. The shapeable fabrics described herein have also be found to exhibit excellent handleability, in particular the shapeable fabrics can be rolled, cut and stacked. Even more surprisingly, the present inventors have found that the shapeable fabrics described herein can provide improvements in the efficiency of the production of reinforced structural components, e.g. wind turbine blades, without detrimentally effecting the infusion or mechanical properties of the fabrics or the final components.

The present inventors have found that the shapeable fabrics described herein can be stacked to form fabric stacks, the shaping component of the stitching system allowing the layers of fabric of the fabric stacks to be adhered to one another to form consolidated fabric stacks exhibiting excellent adhesion. The present inventors have also found that the shapeable fabrics, fabric stacks and consolidated fabric stacks described herein can be straightforwardly shaped and that once shaped the shaped fabrics or fabrics stacks maintain the shaped form (for example, after removal from a mold).

The invention includes the combination of the aspects and preferred features described herein except where such a combination is clearly impermissible or expressly avoided.

### BRIEF DESCRIPTION OF THE FIGURES

Embodiments and experiments illustrating the principles of the invention will now be discussed with reference to the accompanying FIGURE in which:

FIG. 1 is a graph showing the effect of consolidation temperature during the formation of a fabric stack on the inter-ply adhesion between layers of the fabric stack.

### DETAILED DESCRIPTION

Aspects and embodiments of the present invention will now be discussed. Further aspects and embodiments will be apparent to those skilled in the art.

Described herein is a shapeable fabric comprising: first fibers oriented in a first direction; second fibers orientated in a second direction; and a stitching system comprising an infusion component and a shaping component, the infusion and shaping components of stitching system forming a stitching pattern through the fabric, wherein the first fibers comprise glass fibers and/or carbon fibers, the second fibers comprise glass fibers and/or carbon fibers, and the second direction being within 0 to 90 degrees of the first direction.

The first fibers of the shapeable fabric may be referred to as warp fibers. The first fibers may be arranged side by side and substantially parallel to one another. The second fibers of the shapeable fabric may be referred to as weft fibers. The second fibers may be arranged side by side and substantially parallel to one another.

In embodiments, the shapeable fabric comprises first fibers oriented in a first direction and second fibers oriented in a second direction, wherein the second direction is within 0 to 90 degrees of the first direction, for example, within about 10 degrees to about 90 degrees of the first direction, within about 20 degrees to about 90 degrees of the first direction, within about 30 degrees to about 90 degrees of the first direction, within about 40 degrees to about 90 degrees of the first direction, within about 45 degrees to about 90 degrees of the first direction, within about 60 degrees to about 90 degrees of the first direction, within about 70 to about 90 degrees of the first direction, within about 80 to about 90 degrees of the first direction, within about 85 to about 90 degrees of the first direction, within about 88 to about 90 degrees of the first direction, or within about 90 degrees of the first direction.

In embodiments, the shapeable fabric may be a unidirectional fabric or a multiaxial fabric such as a biaxial fabric.

In embodiments, the shapeable fabric is a unidirectional fabric. A unidirectional fabric can comprise second fibers oriented in a second direction wherein the second direction is oriented in a direction greater than 0 degrees of the first direction. For example, a unidirectional fabric may comprise first fibers oriented in a first direction and second fibers oriented in a second direction, wherein the second direction is from about 0 to 90 degrees of the first direction, for example, within about 45 degrees to about 90 degrees of the first direction, within about 60 degrees to about 90 degrees of the first direction, within about 70 to about 90 degrees of the first direction, within about 80 to about 90 degrees of the first direction, within about 85 to about 90 degrees of the first direction, within about 88 to about 90 degrees of the first direction, or within about 90 degrees of the first direction. In a unidirectional fabric the first fibers may constitute greater than about 90 wt. % of the shapeable fabric, for example greater than about 92 wt. % of the shapeable fabric, or at least about 95 wt. % of the shapeable fabric. In a unidirectional fabric the second fibers may constitute up to about 10 wt. %, for example up to about 8 wt. %, or up to about 5 wt. % of the shapeable fabric. In a unidirectional fabric, the second direction may be substantially perpendicularly to the first direction, the first fibers may constitute greater than 92 wt. % of the shapeable fabric, and the second fibers may constitute up to about 8 wt. % of the shapeable fabric. In embodiments, the shapeable fabric is a unidirectional fabric, the second direction is substantially perpendicularly to the first direction and the weight ratio of first fibers to second fibers is in the range of 15:1 to 25:1.

In embodiments, the shapeable fabric is a biaxial fabric. In a biaxial fabric the second direction may be within about 20 degrees to about 90 degrees of the first direction, for example the second direction may be within about 30 degrees to about 90 degrees of the first direction, the second direction may be within about 40 degrees to about 90 degrees of the first direction, the second direction may be within about 45 degrees to about 90 degrees of the first direction, the second direction may be within about 60 degrees to about 90 degrees of the first direction, within about 70 to about 90 degrees of the first direction, within about 80 to about 90 degrees of the first direction, within about 85 to about 90 degrees of the first direction, within about 88 to about 90 degrees of the first direction, or within about 90 degrees of the first direction. In embodiments, the shapeable fabric is a biaxial fabric wherein the second direction is around 25 to 75 degrees of the first direction, for example about 45 degrees of the first direction. In embodiments, the shapeable fabric is a biaxial fabric wherein the second direction is at least 45 degrees of the first direction. In embodiments, the shapeable fabric is a biaxial fabric and the second direction is substantially perpendicular to the first direction. In embodiments where the shapeable fabric is a biaxial fabric the second fibers constitute greater than 5 wt. % of the shapeable fabric. In embodiments where the shapeable fabric is a biaxial fabric the second fibers may constitute at least about 10 wt. % of the shapeable fabric, for example at least about 15 wt. %, at least about 20 wt. %, or at least about 25 wt. % of the shapeable fabric.

In embodiments, at least the first fibers or the second fibers comprise, consist essentially of, or consist of glass fibers.

In embodiments, both the first fibers and the second fibers comprise, consist essentially of, or consist of glass fibers.

The term “glass fibers” is used herein to refer to a plurality of continuous glass filaments (the term “continuous” as used here is used to refer to a fiber/filament that has a length many times longer than its diameter, for example at least about 5000 times longer than its diameter, e.g. at least about 10 000 times longer than its diameter). The glass fibers used in the fabrics described herein may be provided as glass fiber strands (or tows). The glass fibers may be formed by a continuous manufacturing process in which molten glass passes through the holes of a “bushing,” the streams of molten glass thereby formed are solidified into filaments/fibers. The glass fibers described herein (e.g. the glass fibers of the first and/or second fibers) may include a sizing on their surface, e.g. a sizing applied on the glass fibers during formation of the fibers. The sizing can include components such as a film former, lubricant, coupling agent (to promote compatibility between the glass fibers and the resin used to form a composite article comprising the hybrid fabric described herein), etc. that facilitate formation of the glass fibers and/or use thereof in a matrix resin. In some embodiments, the glass fibers of first and/or second fibers include a polyester compatible sizing or an epoxy compatible sizing.

The term “glass fiber strand” or “glass fiber tow” as used herein, refers to a bundle of continuous glass filaments. In embodiments the glass fiber strands or tows are bundles of untwisted glass filaments.

In embodiments, glass fiber strands or glass fiber tows are provided from glass fiber direct rovings. Glass fiber direct rovings are made up of a bundle of continuous untwisted (i.e. substantially parallel, or parallel) glass filaments bonded (as the glass filaments are formed) into a single strand and wound onto a bobbin.

Any suitable glass reinforcing fibers may be employed as the first or second fibers, for example, fibers made from E glass, E-CR glass (such as Advantex™ glass fibers available from Owens Corning), C glass, H glass, S glass, and AR glass types can be used.

In embodiments, the glass fibers referred to herein (for example, the first fibers which may be glass fibers and/or the second fibers that may be glass fibers) have a linear mass density in the range of about 50 Tex to about 5000 Tex, for example about 200 Tex to about 4800 Tex, about 300 Tex to about 2500 Tex, about 300 Tex to about 2400 Tex, or about 600 Tex to about 1200 Tex.

The term “carbon fibers” used herein to refer to a plurality of continuous carbon filaments (the term “continuous” as used here is used to refer to a fiber/filament that has a length many times longer than its diameter, for example at least about 5000 times longer than its diameter, e.g. at least about 10 000 times longer than its diameter). The carbon fibers used in the fabrics described herein may be provided as carbon fiber tows (or strands) which are bundles of continuous carbon filaments. The carbon fibers described herein (e.g. the carbon fibers of the first and/or second fibers) may include a sizing on their surface, e.g. a sizing applied on the carbon fibers during formation of the fibers. The sizing can include components such as a film former, lubricant, coupling agent (to promote compatibility between the carbon fibers and the resin used to form a composite article comprising the hybrid fabric described herein), etc. that facilitate formation of the carbon fibers and/or use thereof in a matrix resin. In some embodiments, the carbon fibers include a polyester compatible sizing or an epoxy compatible sizing.

In embodiments, the carbon fibers have a linear mass density in the range of about 100 Tex to about 5000 Tex, for example about 200 Tex to about 5000 Tex, about 400 Tex to about 5000 Tex, about 600 Tex to about 5000 Tex, about 800 Tex to about 5000 Tex, about 100 Tex to about 4800 Tex, about 200 Tex to about 4800 Tex, 400 Tex to about 4800 Tex, about 600 Tex to about 4800 Tex, about 800 Tex to about 4800 Tex, about 100 Tex to about 2400 Tex, about 200 Tex to about 2400 Tex, about 400 Tex to about 2400 Tex, about 100 Tex to about 2000 Tex, about 200 Tex to about 2000 Tex, about 400 Tex to about 2000 Tex, about 600 Tex to about 2000 Tex, about 800 Tex to about 2000 Tex, or about 1200 Tex.

In embodiments, carbon fibers (where present) are provided by carbon fiber tows (strands of carbon fibers). In embodiments, the carbon fibers tows have a size in the range of 6K to 50K, for example 6K to 24K, or 6K to 12K. For example, the first fibers may be fed from one or more carbon fiber tows having a size in the range of 6K to 50K, for example 6K to 24K, or 6K to 12K. The nomenclature #K means that the carbon tow is made up of #×1,000 individual carbon filaments, i.e. a carbon fiber tow having a size of 6K is made up of approximately 6000 carbon fiber filaments/fibers.

The shapeable fabric is a non-crimp fabric, the first and second fibers are maintained in their respective orientations by the stitching system (as opposed to the first and second fibers being woven together, i.e. a non-crimp fabric is a non-woven fabric).

In embodiments, the shapeable fabric has an areal weight in the range of about 200 g/m² to about 2500 g/m², for example about 300 g/m² to about 2500 g/m², for example about 400 g/m² to about 2000 g/m², for example about 300 g/m² to about 2000 g/m², for example about 500 g/m² to about 1500 g/m², for example about 500 g/m² to about 1300 g/m², for example about 1300 g/m² to about 2500 g/m². The areal weight of the shapeable fabric may be determined according to ISO 3374.

### Stitching System

The stitching system employed in the shapeable fabrics described herein comprises, consists essentially of, or consists of an infusion component and a shaping component.

In embodiments, the stitching system comprises, consists essentially or, or consists of from about 15 wt. % to about 75 wt. % of the infusion component, and from about 25 wt. % to about 85 wt. % of the shaping component by total weight of the stitching system; for example, from about 20 wt. % to about 75 wt. % of the infusion component, and from about 25 wt. % to about 80 wt. % of the shaping component; from about 25 wt. % to about 75 wt. % of the infusion component, and from about 25 wt. % to about 75 wt. % of the shaping component; from about 20 wt. % to about 60 wt. % of the infusion component, and from about 40 wt. % to about 80 wt. % of the shaping component; from about 25 wt. % to about 60 wt. % of the infusion component, and from about 40 wt. % to about 75 wt. % of the shaping component; or from about 25 wt. % to about 50 wt. % of the infusion component, and from about 50 wt. % to about 75 wt. % of the shaping component; from about 20 wt. % to about 50 wt. % of the infusion component, and from about 50 wt. % to about 80 wt. % of the shaping component; or from about 20 wt. % to about 45 wt. % of the infusion component, and from about 55 wt. % to about 80 wt. % of the shaping component by total weight of the stitching system.

In embodiments, the stitching system constitutes from about 0.1 wt. % to about 20 wt. % of the shapeable fabric; for example, from about 0.1 wt. % to about 15 wt. % of the shapeable fabric; from about 0.1 wt. % to about 10 wt. % of the shapeable fabric; from about 0.1 wt. % to about 5 wt. % of the shapeable fabric; from about 0.1 wt. % to about 3 wt. % of the shapeable fabric; from about 0.25 wt. % to about 15 wt. % of the shapeable fabric; from about 0.25 wt. % to about 10 wt. % of the shapeable fabric; from about 0.25 wt. % to about 5 wt. % of the shapeable fabric; from about 0.25 wt. % to about 3 wt. % of the shapeable fabric; from about 0.5 wt. % to about 15 wt. % of the shapeable fabric; from about 0.5 wt. % to about 10 wt. % of the shapeable fabric; from about 0.5 wt. % to about 5 wt. % of the shapeable fabric; or from about 0.5 wt. % to about 3 wt. % of the shapeable fabric.

In embodiments, the shaping component of the stitching system constitutes from about 0.25 wt. % to about 4 wt. % of the shapeable fabric; and/or the infusion component of the stitching system constitutes from about 0.25 wt. % to about 2 wt. % of the shapeable fabric.

In embodiments, the stitching system forms a stitching pattern through the fabric, wherein the stitching pattern is selected from a tricot stitching pattern, a symmetric double tricot stitching pattern, an asymmetric double tricot stitching pattern, a symmetric stitching pattern, and an asymmetric stitching pattern. In embodiments, the stitching system forms a stitching pattern through the fabric, the stitching pattern being a tricot stitching pattern. In embodiments, the stitching system defines a stitching length, the stitching length being in the range of about 2 mm to about 7 mm, for example about 3 mm to about 5 mm.

### Infusion Component

In embodiments, the infusion component of the stitching system has a melting point of at least about 200 °C, for example at least about 220 °C. In embodiments, the infusion component of the stitching system has a melting point in the range of about 200 °C to about 350 °C, or about 220 °C to about 330 °C. In some embodiments, the infusion component of the stitching system has a melting point around 250 °C. The melting point of the infusion component may be determined by differential scanning calorimetry (i.e. the temperature of the peak heat flow obtained by DSC analysis). The melting point of the infusion component may be determined using differential scanning calorimetry (DSC) according to EN ISO 11357-3:2018 (determination of temperature and enthalpy of melting and crystallization). The melting point of the infusion component may be determined using differential scanning calorimetry (DSC) according to EN ISO 11357-3:2018 (determination of temperature and enthalpy of melting and crystallization) wherein the melting point is determined as the value provided on the second heating cycle. The melting point of the the infusion component may be determined according to the EN ISO 11357-3:2018 test method by heating the infusion component under an air flow of 80 mL/min at a heating rate of 10K/min, heating from −60 °C to 300 °C. In embodiments, the melting point of the infusion component may be determined according to the EN ISO 11357-3:2018 test method by heating the infusion component under an air flow of 80 mL/min at a heating rate of 10K/min, heating from −60 °C to 300 °C and then holding for 5 mins at 300 °C before cooling from 300 °C to −60 °C at a cooling rate of 10K/min and then holding for 5 mins at −60 °C before heating from −60 °C to 300 °C again at a heating rate of 10K/min and the melting point being determined as the value provided on the second heating cycle.

In embodiments, infusion component of the stitching system has a linear density in the range of about 50 dTex to about 200 dTex, for example a linear density in the range of about 70 dTex to about 200 dTex, a linear density in the range of about 70 dTex to about 175 dTex, or a linear density in the range of about 76 dTex to about 167 dTex.

In embodiments, the infusion component comprises, comprises essentially, or consists of a polyester stitching yarn having a melting point in the range of about 200 °C to about 350 °C and a linear density in the range of about 50 dTex to about 200 dTex.

### Shaping Component

In embodiments, the shaping component of the stitching system has a melting point of less than about 120 °C, for example less than about 100 °C, less than about 90 °C, less than about 80 °C, less than about 75 °C, less than about 70 °C, or less than about 65 °C. In embodiments, the shaping component of the stitching system has a melting point in the range of about 40 °C to about 120 °C, for example about 50 °C to about 100 °C, about 50 °C to about 90 °C, about 55 °C to about 75 °C, or about 55 °C to about 65 °C. The melting point of the shaping component may be determined by differential scanning calorimetry (i.e. the temperature of the peak heat flow obtained by DSC analysis). The melting point of the shaping component may be determined using differential scanning calorimetry (DSC) according to EN ISO 11357-3:2018 (determination of temperature and enthalpy of melting and crystallization). The melting point of the shaping component may be determined using differential scanning calorimetry (DSC) according to EN ISO 11357-3:2018 (determination of temperature and enthalpy of melting and crystallization) wherein the melting point is determined as the value provided on the second heating cycle. The melting point of the the shaping component may be determined according to the EN ISO 11357-3:2018 test method by heating the shaping component under an air flow of 80 mL/min at a heating rate of 10K/min, heating from −60 °C to 150 °C. In embodiments, the melting point of the shaping component may be determined according to the EN ISO 11357-3:2018 test method by heating the shaping component under an air flow of 80 mL/min at a heating rate of 10K/min, heating from −60 °C to 150 °C and then holding for 5 mins at 150 °C before cooling from 150 °C to −60 °C at a cooling rate of 10K/min and then holding for 5 mins at −60 °C before heating from −60 °C to 150 °C again at a heating rate of 10K/min and the melting point being determined as the value provided on the second heating cycle.

In embodiments, the shaping component of the stitching system has a linear density in the range of about 50 dTex to about 400 dTex, for example a linear density in the range of about 100 dTex to about 400 dTex, a linear density in the range of about 100 dTex to about 350 dTex, or a linear density in the range of about 110 dTex to about 330 dTex.

In embodiments, the shaping component comprises, or is composed of polyester or polyamide. For example, the shaping component may be composed of polycaprolactone or a copolyamide. For example, the shaping component may be selected from a polyester yarn or filament, and a polyamide yarn or filament. For example, the shaping component may be selected from a polyester yarn or filament, and a polyamide yarn or filament, the shaping component having a melting point in the range of about 40 °C to about 120 °C, for example about 50 °C to about 100 °C, about 50 °C to about 90 °C, about 55 °C to about 75 °C, or about 55 °C to about 65 °C.

In embodiments, the shaping component comprises, comprises essentially, or consists of a polycaprolactone filament or yarn having a melting point in the range of about 55 °C to about 65 °C and a linear density in the range of about 100 dTex to about 400 dTex.

### Shapeable Fabric

In embodiments, the shapeable fabric has a fabric surface, and at least 50 wt. % of the shaping component is present on the fabric surface, for example at least about 60 wt. % of the shaping component is present on the fabric surface, at least about 70 wt. % of the shaping component is present on the fabric surface, or at least about 75 wt. % of the shaping component is present on the fabric surface. The term “fabric surface” used herein, may be used to refer to the first face of the fabric formed by the first fibers, where the first fibers form a first layer of the fabric and are disposed on a second layer of the fabric formed from the second fibers, the first face being the face of the first layer opposing the second layer formed by the second fibers. The amount of shaping component present on the fabric surface can be determined by first determining the total amount of the components of the stitching system on a first face of the fabric from the geometry of the stitching pattern on the first face, the stitch length and the total linear density of the infusion and shaping components, and then determining the amount of shaping component present on the surface from the relative amounts of infusion and shaping components making up the stitching system.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers and/or carbon fibers, the second fibers comprise glass fibers and/or carbon fibers, and the second direction being within 0 to 90 degrees of the first direction, and
   wherein the infusion component constitutes from about 15 wt. % to about 75 wt. % of the stitching system, and the shaping component constitutes from about 25 wt. % to about 85 wt. % of the stitching system, and
   wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers, the second fibers comprise glass fibers, and the second direction being within 0 to 90 degrees of the first direction, and
   wherein the infusion component constitutes from about 15 wt. % to about 75 wt. % of the stitching system, and the shaping component constitutes from about 25 wt. % to about 85 wt. % of the stitching system, and
   wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers and/or carbon fibers, the second fibers comprise glass fibers and/or carbon fibers, and the second direction being within 0 to 90 degrees of the first direction, and
   wherein the infusion component constitutes from about 25 wt. % to about 75 wt. % of the stitching system, and the shaping component constitutes from about 25 wt. % to about 75 wt. % of the stitching system, and
   wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers, the second fibers comprise glass fibers, and the second direction being within 0 to 90 degrees of the first direction, and
   wherein the infusion component constitutes from about 25 wt. % to about 75 wt. % of the stitching system, and the shaping component constitutes from about 25 wt. % to about 75 wt. % of the stitching system, and
   wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers and/or carbon fibers, the second fibers comprise glass fibers and/or carbon fibers, and the second direction being within 0 to 90 degrees of the first direction, and
wherein the infusion component constitutes from about 25 wt. % to about 75 wt. % of the stitching system, and the shaping component constitutes from about 25 wt. % to about 75 wt. % of the stitching system, and
   wherein the stitching system constitutes from about 0.1 wt. % to about 10 wt. % of the shapeable fabric, and
   wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers, the second fibers comprise glass fibers, and the second direction being within 0 to 90 degrees of the first direction, and
   wherein the infusion component constitutes from about 25 wt. % to about 75 wt. % of the stitching system, and the shaping component constitutes from about 25 wt. % to about 75 wt. % of the stitching system, and
   wherein the stitching system constitutes from about 0.1 wt. % to about 10 wt. % of the shapeable fabric, and
   wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
   wherein the first fibers comprise glass fibers and/or carbon fibers, the second fibers comprise glass fibers and/or carbon fibers, and the second direction being within 0 to 90 degrees of the first direction, and
      wherein the infusion component constitutes from about 25 wt. % to about 75 wt. % of the stitching system, and the shaping component constitutes from about 25 wt. % to about 75 wt. % of the stitching system, and
      wherein the stitching system constitutes from about 0.1 wt. % to about 5 wt. % of the shapeable fabric, and
      wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers, the second fibers comprise glass fibers, and the second direction being within 0 to 90 degrees of the first direction, and
   wherein the infusion component constitutes from about 25 wt. % to about 75 wt. % of the stitching system, and the shaping component constitutes from about 25 wt. % to about 75 wt. % of the stitching system, and
   wherein the stitching system constitutes from about 0.1 wt. % to about 5 wt. % of the shapeable fabric, and
   wherein the shaping component of the stitching system has a melting point of less than about 120 °C, and wherein the infusion component of the stitching system has a melting point of at least about 200 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers and/or carbon fibers, the second fibers comprise glass fibers and/or carbon fibers, and the second direction being within 0 to 90 degrees of the first direction, and
wherein the infusion component constitutes from about 25 wt. % to about 75 wt. % of the stitching system, and the shaping component constitutes from about 25 wt. % to about 75 wt. % of the stitching system, and
   wherein the stitching system constitutes from about 0.1 wt. % to about 10 wt. % of the shapeable fabric, and
   wherein the shaping component of the stitching system has a melting point of less than about 100 °C, and wherein the infusion component of the stitching system has a melting point in the range of about 200 °C to about 350 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers and/or carbon fibers, the second fibers comprise glass fibers and/or carbon fibers, and the second direction being within 0 to 90 degrees of the first direction, and
wherein the infusion component constitutes from about 20 wt. % to about 60 wt. % of the stitching system, and the shaping component constitutes from about 40 wt. % to about 80 wt. % of the stitching system, and
   wherein the stitching system constitutes from about 0.1 wt. % to about 10 wt. % of the shapeable fabric, and
   wherein the shaping component of the stitching system has a melting point of less than about 100 °C, and wherein the infusion component of the stitching system has a melting point in the range of about 200 °C to about 350 °C.

In embodiments, the shapeable fabric comprises:
first fibers oriented in a first direction;
second fibers oriented in a second direction; and
a stitching system comprising an infusion component and a shaping component, the
infusion and shaping components of stitching system forming a stitching pattern through the fabric,
wherein the first fibers comprise glass fibers and/or carbon fibers, the second fibers comprise glass fibers and/or carbon fibers, and the second direction being within 0 to 90 degrees of the first direction, and
wherein the infusion component constitutes from about 25 wt. % to about 60 wt. % of the stitching system, and the shaping component constitutes from about 40 wt. % to about 75 wt. % of the stitching system, and
   wherein the stitching system constitutes from about 0.1 wt. % to about 10 wt. % of the shapeable fabric, and
   wherein the shaping component of the stitching system has a melting point of less than about 100 °C, and wherein the infusion component of the stitching system has a melting point in the range of about 200 °C to about 350 °C.

### Fabric Stack

A fabric stack comprises at least two layers of a shapeable fabric as described herein.

In embodiments, a fabric stack comprises at least two layers of a shapeable fabric as described herein wherein one layer of shapeable fabric is directly disposed on another layer of shapeable fabric. In embodiments, the fabric stack comprises at least 3 layers of a shapeable fabric as described herein, for example at least 4 layers, at least 5 layers, at least 6 layers or at least 8 layers of a shapeable fabric as described herein. In embodiments, the fabric stack comprises up to 50 layers of a shapeable fabric as described herein, for example, up to 30 layers, up to 25 layers, up to 20 layers up to 15 layers, up to 10 layers of a shapeable fabric as described herein. In embodiments, the fabric stack comprises 2-50 layers of a shapeable fabric as described herein, for example 4-30 layers, or 6-25 layers of a shapeable fabric as described herein. In embodiments, the fabric stack comprises a plurality of layers of shapeable fabric as described herein, wherein the each of the plurality of layers of shapeable fabric is directly disposed on another of the plurality of layers of shapeable fabric.

In embodiments, the layers of the fabric stack are adhered to one another. A fabric stack in which layers of the fabric stack are adhered to one another may be referred to herein as a “consolidated fabric stack”.

In embodiments, the layers of the fabric stack may be adhered to one another by a suitable treatment such as heating, curing, or exposure to UV radiation. In embodiments, the layers of the fabric stack may be adhered to one another by heating the fabric stack such that the shaping component of the stitching system of a first layer of shapeable fabric adheres the first layer of shapeable fabric to a second layer of shapeable fabric.

In embodiments, the layers of the fabric stack may be adhered to one another by heating the fabric stack to a temperature of at least the melting point of the shaping component of the stitching system, for example to a temperature at least about 5 °C greater than the melting point of the shaping component of the stitching system, to a temperature at least about 10 °C greater than the melting point of the shaping component of the stitching system, or to a temperature at least about 15 °C greater than the melting point of the shaping component of the stitching system. In embodiments, the layers of the fabric stack may be adhered to one another by heating the fabric stack to a temperature of at least about 60 °C, for example at least about 65 °C, at least about 70 °C, or at least about 80 °C. In embodiments, the layers of the fabric stack may be adhered to one another by heating the fabric stack to a temperature of up to about 150 °C, for example up to about 130 °C, up to about 120 °C, or up to about 100 °C. In embodiments, the layers of the fabric stack may be adhered to one another by heating the fabric stack to a temperature in the range of about 60 °C to about 120 °C, for example about 65 °C to about 100 °C. In embodiments, the layers of the fabric stack may be adhered to one another by heating the fabric stack as described above for about 1 minute or more, for example up to about 1 hour.

In embodiments, the consolidated fabric stack may be produced by heating the fabric stack under vacuum, for example heating the fabric stack at a pressure below atmospheric pressure, for example a pressure in the range of about 100 mbar to about 1000 mbar, or about 100 mbar to about 900 mbar, about 100 mbar to about 800 mbar, about 100 mbar to about 700 mbar, about 100 mbar to about 600 mbar, or about 100 mbar to about 400 mbar.

In embodiments, the fabric stack is exposed to increased temperature (i.e. heated) and/or reduced pressure for a time period of up to about 5 hours, for example up to about 3 hours, up to about 2 hours or up to about 1 hour to form a consolidated fabric stack.

In embodiments, the inter-ply adhesion strength between consecutive layers of the consolidated fabric stacks described herein is at least about 5 N/50 mm, for example at least about 6 N/50 mm, or at least about 8 N/50 mm. Inter-ply adhesion can be determined according to the T-peel ISO 11339 standard test method or a similar method.

In embodiments, the fabric stack described herein may be impregnated with a resin and the resin cured to form a composite article.

### Process for Producing a Shapeable Fabric

A process for producing a shapeable fabric may comprise:
providing first fibers oriented in a first direction and second fibers oriented in a second direction, wherein the first fibers comprise glass fibers and/or carbon fibers, the second fibers comprise glass fibers and/or carbon fibers, and the second direction being within 0 to 90 degrees of the first direction; and
stitching the first fibers and second fibers together using a stitching system, the stitching system comprising an infusion component and a shaping component, wherein the stitching system comprises from about 25 wt. % to about 85 wt. % of the infusion component and from about 15 wt. % to about 75 wt. % of the shaping component by total weight of the stitching system.

In embodiments, stitching the first fibers and second fibers together using a stitching system comprises stitching the first fibers and second fibers together with the infusion component and the shaping component simultaneously.

### Shaped Component

A shaped component comprises a fabric stack as described herein.

A shaped component may be produced by:
a) providing a fabric stack as described herein;
b) shaping the fabric stack; and
c) heating the shaped stack, for example at a temperature up to about 150 °C.

In embodiments, heating the fabric stack comprises heating the fabric stack at a temperature of at least about 50 °C, for example at least about 60 °C, at least about 70 °C, at least about 80 °C, at least about 90 °C, or at least about 100 °C. In embodiments, heating the fabric stack comprises heating the fabric stack at a temperature of up to about 150 °C, for example up to about 130 °C, or up to about 120 °C. In embodiments, heating the fabric stack comprises heating the fabric stack at a temperature in the range of about 50 °C to about 150 °C, for example about 70 °C to about 130 °C, or about 80 °C to about 120 °C.

In embodiments, producing a shaped component may comprise heating the fabric stack under vacuum, for example heating the fabric stack at a pressure below atmospheric pressure, for example a pressure in the range of about 100 mbar to about 1000 mbar, or about 100 mbar to about 900 mbar, about 100 mbar to about 800 mbar, about 100 mbar to about 700 mbar, about 100 mbar to about 600 mbar, or about 100 mbar to about 400 mbar.

In embodiments, the fabric stack is exposed to increased temperature (i.e. heated) and/or reduced pressure for a time period of up to about 5 hours, for example up to about 3 hours, up to about 2 hours or up to about 1 hour to form a shaped article. In embodiments, the fabric stack is exposed to increased temperature (i.e. heated) and/or reduced pressure for a time period of at least about 10 mins, for example at least about 30 mins to form a shaped article. In embodiments, the fabric stack is exposed to increased temperature (i.e. heated) and/or reduced pressure for a time period of about 10 mins to about 5 hours, for example about 30 mins to about 2 hours, or about 30 mins to about 1 hour.

In embodiments, shaping the fabric stack involves placing the fabric stack over or in a mold. In embodiments, shaping the fabric stack involves placing the fabric stack over or in a mold and applying increased heat and/or reduced pressure to the fabric stack.

In embodiments, the shaped component described herein may be impregnated with a resin, for example an epoxy resin or a polyester resin, and the resin cured to form a composite article.

### EXAMPLES

The following illustrates examples of the fabrics and related aspects described herein. Thus, these examples should not be considered to restrict the present disclosure, but are merely in place to teach how to carry out the processes and obtain the products of the present disclosure.

### Stitching System Used in the Examples

Infusion component—an infusion polyester stitching yarn having a linear density of 76 dTex was employed as the infusion component in the stitching systems employed in the following Examples. The infusion polyester stitching yarn had a melting point in the range of 250-260 °C determined by differential scanning calorimetry as the temperature at which the polyester stitching yarn became entirely molten (i.e. the temperature of the peak heat flow obtained by DSC analysis). The melting point of the infusion component was determined according to the EN ISO 11357-3:2018 test method by heating the infusion component under an air flow of 80 mL/min at a heating rate of 10K/min, heating from −60 °C to 300 °C and then holding for 5 mins at 300 °C before cooling from 300 °C to −60 °C at a cooling rate of 10K/min and then holding for 5 mins at −60 °C before heating from −60 °C to 300 °C again at a heating rate of 10K/min and the melting point being determined as the value provided on the second heating cycle.

Shaping component—a polyester shaping yarn (specifically a polycaprolactone yarn made up of 34 filaments, each filament having a diameter of 21 μm) having a linear density of 167 dTex and a melting point of approximately 60 °C (determined by differential scanning calorimetry as the temperature at which the polyester stitching yarn became entirely molten (i.e. the temperature of the peak heat flow obtained by DSC analysis)) was employed as the shaping component in the stitching systems employed in the following Examples. The melting point of the shaping component was determined according to the EN ISO 11357-3:2018 test method by heating the shaping component under an air flow of 80 mL/min at a heating rate of 10K/min, heating from −60 °C to 120 °C and then holding for 5 mins at 120 °C before cooling from 120 °C to −60 °C at a cooling rate of 10K/min and then holding for 5 mins at −60 °C before heating from −60 °C to 120 °C again at a heating rate of 10K/min and the melting point being determined as the value provided on the second heating cycle.

### Example 1

A shapeable unidirectional fabric was produced by providing a first layer consisting of first glass fibers oriented in the 0° direction (i.e. aligned with the length of the fabric) disposed on a second layer of second glass fibers oriented substantially perpendicular to the 0° direction (i.e. substantially perpendicular to the length of the fabric) and stitching the first fibers and second fibers together using a stitching system. The first fibers had an areal weight of 1322 g/m² and the second fibers had an areal weight of 75 g/m². The stitching system consisted of a polyester infusion yarn and a polycaprolactone shaping yarn as described above. The first and second glass fibers were first stitched together to maintain their respective orientations using the polyester stitching yarn and the polycaprolactone yarn simultaneously. The weight ratio of polycaprolactone shaping yarn to polyester infusion yarn of the stitching system provided was 2:1. A double equal pillar tricot stitch pattern was used to stitch the first and second fibers together using the infusion component and the shaping component of the stitching system, such that a double equal pillar tricot stitch pattern (a symmetric combination of pillar and tricot stitch) was formed through the shapeable fabric in a direction substantially perpendicular to the 0° direction.

### Example 2

A shapeable fabric was produced as described in Example 1 except that a double tricot stitching pattern was used to stitch the first and second fibers together using the infusion component and the shaping component of the stitching system, such that a double tricot stitching pattern was formed through the shapeable fabric.

### Comparative Example 3

A shapeable fabric was produced as described in Example 1, except that the stitching system consisted only of the shaping component, i.e. no infusion component was employed.

### Comparative Example 4

A shapeable fabric was produced as described in Example 2, except that the stitching system consisted only of the shaping component, i.e. no infusion component was employed.

### Example 5

A shapeable fabric was produced as described in Example 1, except that the weight ratio of polycaprolactone shaping yarn to polyester infusion yarn of the stitching system provided was 1:1, and an asymmetric double tricot stitching pattern was used to stitch the first and second fibers together using the infusion component and the shaping component of the stitching system, such that a asymmetric double tricot pattern was formed through the shapeable fabric.

Table 1 below summarises the stitching systems employed along with the amount of the infusion component and the shaping component on the first face of the shapeable fabric (the first face being the surface of the first layer opposing the second fibers). The amount of yarn on the first face (in the unidirectional fabrics, the first face was selected as the face formed from the first fibers, the first fibers present in an amount of at least 90 wt. % of the fabric in the unidirectional fabrics) was determined from the geometry of the stitching pattern on the first face, the stitch length and the total linear density of the infusion and shaping components.

For example, the amount of yarn of the stitching system on the first face of the shapeable fabric produced in Example 2 was determined as follows:

Length of a single stitch was determined using Pythagoras's theorem from the stitch length of stitching pattern (measured in the 0° direction) and the stitch width of the stitching pattern (measured along the 90° direction).

The total stitching yarn weight at the surface of the shapeable fabric can then be calculated as follows:

Total stitching yarn weight at surface=total number of stitches per m of fabric×length of single stitch×linear density of stitching yarn

The relative amounts of shaping and infusion components can then be used to determine the amount of shaping component on the first face of the fabric.

The amount of yarn on the first face of the fabric is determined by the stitching pattern used to stitch the first and second fibers together with the stitching system.

TABLE 1

| | | Infusion PET | | Shaping PCL |
|---|---|---|---|---|
| | Infusion | yarn on first | Shaping | yarn on first |
| | PET yarn | face of fabric | PCL yarn | face of fabric |
| Example | (g/m²) | (g/m²) | (g/m²) | (g/m²) |
| Ex. 1 | 6.5 | 2.6 | 13.1 | 5.7 |
| Ex. 2 | 6.8 | 4.9 | 13.6 | 10.8 |
| C. Ex. 3 | 0 | 0 | 28.7 | 11.4 |
| C. Ex. 4 | 0 | 0 | 29.8 | 21.5 |
| Ex. 5 | 6.8 | 4.9 | 7.4 | 5.4 |

### Infusion Tests

The shapeable fabrics produced according to Examples 1, 2 and 5 and Comparative Examples 2 and 3 were then formed into fabric stacks by stacking 5 layers, a different fabric stack formed for each of the shapable fabrics of Examples 1, 2 and 5 and Comparative Examples 2. The fabrics stacks were consolidated by being placed under vacuum (pressure reduced by 0.6 bar) and heated for 1 hour at 65 °C. The consolidated fabric stacks were then cooled to room temperature and removed from the vacuum. The cooled consolidated fabric stacks were then infused this polyester resin under vacuum (pressure reduction of 0.6 bar) and the infusion speed was measured in the first direction and the second direction.

The shapeable fabrics of Examples 1, 2 and 5 were found to provide consolidated fabric stacks having good infusion properties (similar to those of a reference fabric which was prepared according to Example 1 but containing a stitching system having no shaping component) in both the first and second directions. The infusion properties of the shapeable fabrics of Examples 1, 2 and 5 was found to be much improved in the second direction compared to the shapeable fabrics produced according to comparative examples 3 and 4 (fabrics containing a stitching system containing no infusion component).

### Shaping Tests

The shapeable fabrics were then formed into fabric stacks by stacking 6 layers on a V-shape mold. The shaped stacks were heated at 65 °C for 1 hours, a different fabric stack formed for each of the shapable fabrics of Examples 1, 2 and 5, to form shaped components. All of the shaped components exhibited good shape retention and rigidity. The shaped components formed from the shapeable fabrics of Examples 1 and 2 were found to have improved rigidity when handled compared to the shaped component formed from the shapeable fabric of Example 5 due to the greater amount of shaping component employed in the fabrics of Examples 1 and 2.

### Stiffness Tests

The shapeable fabrics produced according to Examples 1, 2 and 5 and Comparative Examples 2 and 3 were then formed into fabric stacks by stacking 2 layers (each having a size of 50 mm×20 mm), a different fabric stack formed for each of the shapable fabrics of Examples 1, 2 and 5 and Comparative Examples 2. The fabrics stacks were consolidated by being placed under vacuum (pressure reduced by 0.6 bar) and heated for 1 hour at 65 °C. The consolidated fabric stacks were then cooled to room temperature and removed from the vacuum.

Each of the cooled consolidated fabric stacks then underwent a stiffness test using a bending tester (Standard DIN 53121). One repetition per sample was done to avoid memory effect of the coupons after first bending. During the tests, the bending angle was set to 5°, testing length at 25 mm (distance between clamp and sensor).

It was found that the stiffness of the fabric stacks was directly related to the total amount of shaping component employed in the stitching system, but that the amount of shaping component on the first face of the fabrics also influenced the stiffness which resulted in the fabric stack of Example 2 having a greater stiffness than the fabric stack of Example 1 due to the greater amount of shaping component on the first face of the fabric.

Therefore, the present inventors have found that employing a stitching system comprising both infusion and shaping components as described herein to provide a non-crimp fabric provides a shapeable fabric exhibiting good infusion and stiffness properties.

### Fatigue Resistance

The fatigue properties discussed below can be determined under cyclic loading conditions with a test method performed according to ISO 13003:2003 or any other similar method.

The present inventors have also found that shapeable fabrics described herein, for example the shapeable fabrics of Examples 1, 2 and 5, can be incorporated into composite articles to produce composite articles having good fatigue resistance. For example, shapeable fabrics of Examples 1, 2 and 5 were formed into fabric stacks as described above in relation to the infusion tests and impregnated with polyester resin as described above in relation to the infusion tests to form composite sheets. The composite sheets containing shapeable fabrics of the above-mentioned Examples underwent fatigue testing and were found to have a maximum strain in the range of from 0.7 to 0.9% for 1 million cycles and a maximum stress range from 250 to 350 MPa for 1 million cycles. The results obtained by the inventors in relation to the maximum strain and stress of the samples tested also indicate (by the slope of the fatigue curve obtained from the results) that excellent fatigue performance is expected at even higher number of cycles.

Following the fatigue testing described above, the present inventors have surprisingly found that the fatigue resistance for composite articles comprising the shapeable fabrics described herein (for example the shapeable fabrics of Examples 1, 2 and 5) exhibit much improved fatigue resistance compared to comparative composite materials containing standard comparative fabrics (i.e., fabrics such as those described in Examples 1, 2 and 5 except the stitching system contains no shaping component).

### Inter-Ply Adhesion

The present inventors have also found that the shapeable fabrics described herein, for example the shapeable fabrics of Examples 1, 2 and 5, exhibit excellent inter-ply adhesion between consecutive layers of shapeable fabric that have been consolidated by exposure to temperature around or above the melting point of the shaping component of the stitching system.

Inter-ply adhesion can be determined according to the T-peel ISO 11339 standard test method or a similar method. Such a test method was used to evaluate the inter-ply adhesion of consolidated fabric stacks formed from layers of shapeable fabrics produced according to Examples 1, 2 and 5. The fabrics stacks were consolidated by being placed under vacuum (pressure reduced by 0.6 bar) and heated for 1 hour at 65 °C. The consolidated fabric stacks were then cooled to room temperature and removed from the vacuum. Inter-ply adhesion was then evaluated for each of the consolidated stacks. The consolidated fabrics stacks produced from fabrics described herein (for example as described in Examples 1, 2 and 5) were found to exhibit excellent inter-ply adhesion, the adhesion strength increasing with increased amount of the shaping yarn. It is surprising that the adhesion strength was found to be so good following consolidation at very low temperature (65 °C).

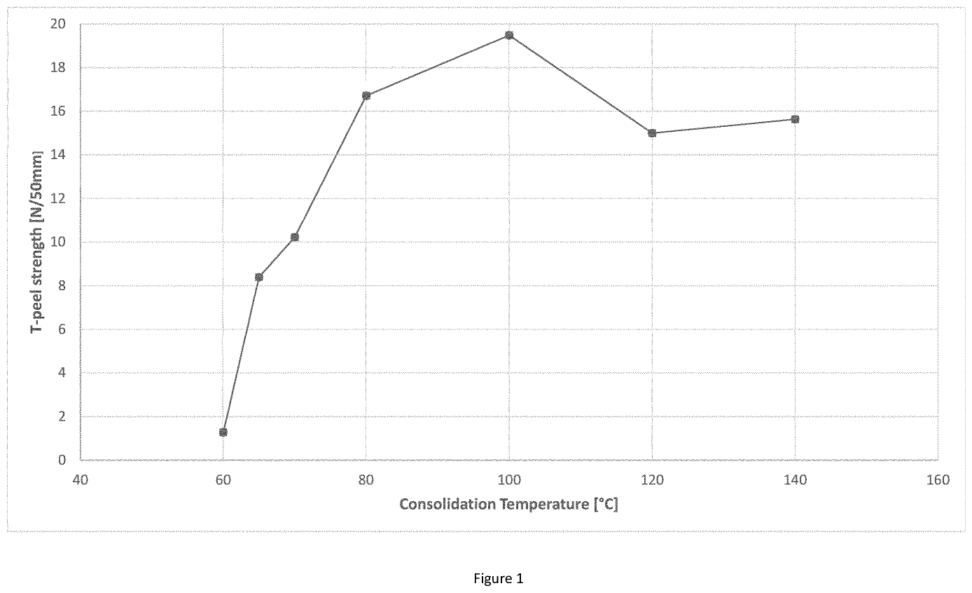

The inter-ply adhesion of consolidated fabric stacks formed from layers of shapeable fabric produced according to Example 2 was investigated further. The fabrics stacks were consolidated by being placed under vacuum (pressure reduced by 0.6 bar) and heated for 1 hour, with each fabric stack being heated to a different temperature in the range of 60 °C to 140 °C. The consolidated fabric stacks were then cooled to room temperature and removed from the vacuum. Inter-ply adhesion was then evaluated for each of the consolidated stacks following a test method based on the T-peel ISO 11339 standard test method. The results are shown in the graph provided in FIG. 1 which shows the adhesion strength (T-peel strength in units of N/50 mm) against the temperature at which the fabric stack was consolidated. Not only is it surprising that the adhesion strength was found to be so good following consolidation at very low temperature (65 °C), but it is further surprising that the increase in inter-ply adhesion increased dramatically by increasing the consolidation temperature from 60 °C to 80 °C.

The present inventors have found that the shapeable fabrics described herein have low stiffness during lay-up and molding while providing excellent adhesion between layers after consolidation. These properties make the shapeable fabrics described herein are very useful in providing reinforced structural components such as wind turbine blades.

The inventors also investigated the porosity of laminates formed using fabrics stacks formed of fabrics of each of Examples 1-5 above, the fabrics stacks infused with polyester resin to form the laminates. Using a standard Archimedes method each of the laminates (containing the fabrics of Examples 1-5) was found to have acceptable mean porosity values (between 0 and 2%) demonstrating that the inclusion of the shaping yarn did not detrimentally impact porosity.

The inventors expect fabrics similar to those of Examples 1-5 but containing a polyamide shaping yarn having a melting temperature of around 85 °C to provide similarly improved results to the shapeable fabrics produced according to Examples 1-5, although consolidation/shaping required a slightly higher temperature of 85-90 °C.

The inventors expect that shapeable fabrics having other configurations, for example biaxial fabrics, as described herein provide shapeable fabrics providing similar advantages to the unidirectional shapeable fabrics employed in these Examples.

Additionally, the inventors have found that the fabric stacks or shaped components described herein can be employed to remarkably improve lay-up speed of composite articles including the shaped components described herein. For example, shaped components comprising the shapeable fabrics described herein can be employed during wind turbine blade manufacture by incorporating a shaped component directly into a wind turbine blade during the lay-up procedure.

The features disclosed in the foregoing description, or in the following claims expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

If a standard test is mentioned herein, unless otherwise stated, the version of the test to be referred to is the most recent at the time of filing this patent application.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A shapeable fabric comprising:
a plurality of first fibers oriented in a first direction;
a plurality of second fibers oriented in a second direction; and
a stitching system comprising an infusion component and a shaping component, the infusion and shaping components of the stitching system forming a stitching pattern through the fabric,
wherein the first fibers comprise at least one of glass fibers and carbon fibers,
wherein the second fibers comprise at least one of glass fibers and carbon fibers,
wherein the second direction is within 0 degrees to 90 degrees of the first direction, and
wherein the infusion component constitutes from about 15 wt. % to about 75 wt. % of the stitching system, and the shaping component constitutes from about 25 wt. % to about 85 wt. % of the stitching system.

2. The shapeable fabric of claim 1, wherein the shaping component of the stitching system has a melting point of less than about 100 °C.

3. The shapeable fabric of claim 1, wherein the infusion component of the stitching system has a melting point in the range of about 200 °C to about 350 °C.

4. The shapeable fabric of claim 1, wherein the infusion component constitutes from about 20 wt. % to about 60 wt. % of the stitching system, and the shaping component constitutes from about 40 wt. % to about 80 wt. % of the stitching system.

5. The shapeable fabric of claim 1, wherein the infusion component constitutes from about 25 wt. % to about 75 wt. % of the stitching system, and the shaping component constitutes from about 25 wt. % to about 75 wt. % of the stitching system.

6. The shapeable fabric of claim 1, wherein the shapeable fabric has a fabric surface, and at least 50 wt. % of the shaping component is present on the fabric surface.

7. The shapeable fabric of claim 1, wherein the shaping component is composed of polyester or polyamide.

8. The shapeable fabric of claim 1, wherein the shapeable fabric has an areal weight in the range of about 300 g/m² to about 2500 g/m².

9. The shapeable fabric of claim 1, wherein the stitching system constitutes from about 0.1 wt. % to about 20 wt. % of the shapeable fabric.

10. The shapeable fabric of claim 1, wherein the infusion component of the stitching system has a linear density in the range of about 50 dTex to about 200 dTex.

11. The shapeable fabric of claim 1, wherein the shaping component of the stitching system has a linear density in the range of about 50 dTex to about 400 dTex.

12. The shapeable fabric of claim 1, wherein the shaping component of the stitching system constitutes from about 0.25 wt. % to about 4 wt. % of the shapeable fabric; and/or the infusion component of the stitching system constitutes from about 0.25 wt. % to about 2 wt. % of the shapeable fabric.

13. A fabric stack comprising at least two layers of a shapeable fabric, wherein each layer of the shapeable fabric comprises:
a plurality of first fibers oriented in a first direction;
a plurality of second fibers oriented in a second direction; and
a stitching system comprising an infusion component and a shaping component, the infusion and shaping components of the stitching system forming a stitching pattern through the fabric,
wherein the first fibers comprise at least one of glass fibers and carbon fibers,
wherein the second fibers comprise at least one of glass fibers and carbon fibers,
wherein the second direction is within 0 degrees to 90 degrees of the first direction, and
wherein the infusion component constitutes from about 15 wt. % to about 75 wt. % of the stitching system, and the shaping component constitutes from about 25 wt. % to about 85 wt. % of the stitching system, and
wherein a first layer of the shapeable fabric is directly disposed on a second layer of the shapeable fabric.

14. The fabric stack of claim 13, wherein the layers of the shapeable fabric are consolidated so that an inter-ply adhesion strength between consecutive layers of the fabric stack is at least about 6 N/50 mm.

15. (canceled)

16. A process for producing a shapeable fabric, the process comprising:
providing a plurality of first fibers oriented in a first direction and a plurality of second fibers oriented in a second direction, wherein the first fibers comprise at least one of glass fibers and carbon fibers, wherein the second fibers comprise at least one of glass fibers and carbon fibers, and wherein the second direction is within 0 degrees to 90 degrees of the first direction; and
stitching the first fibers and second fibers together using a stitching system, wherein the stitching system comprises an infusion component and a shaping component, wherein the infusion component constitutes from about 15 wt. % to about 75 wt. % of the stitching system, and wherein the shaping component constitutes from about 25 wt. % to about 85 wt. % of the stitching system.

17. The process of claim 16, wherein the shaping component of the stitching system has a melting point of less than about 100 °C.

18. The process of claim 16, wherein the infusion component of the stitching system has a melting point in the range of about 200 °C to about 350 °C.

19. The process of claim 16, wherein the infusion component constitutes from about 25 wt. % to about 75 wt. % of the stitching system, and the shaping component constitutes from about 25 wt. % to about 75 wt. % of the stitching system.

20-21. (canceled)
